(19) United States
(12) Patent Application Publication
(10) Pub. No.: US 2006/0041492 A1
(43) Pub. Date: Feb. 23, 2006

(54) Financial data processing method and system

(76) Inventors: Norio Takahashi, Yokohama (JP); Toshiyuki Yamagishi, Tokyo (JP); Miyoko Namioka, Yokohama (JP); Mizuhiro Sakai, Saitama (JP); Shoko Matsushita, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/962,500

(22) Filed: Oct. 13, 2004

(30) Foreign Application Priority Data
Aug. 23, 2004 (JP) 2004-241787

(51) Int. Cl. G06Q 40/00

(52) U.S. Cl. 705/35

(57) ABSTRACT

When a name of an enterprise to be evaluated and a plurality of evaluation definition names entered by a client are received by a server, an overall investment evaluation creation program creates an overall investment evaluation from a plurality of investment evaluations created according to a plurality of XBRL-formatted evaluation definitions corresponding to the plurality of evaluation definition names and displays the overall investment evaluation to the client.

### BACKGROUND OF THE INVENTION

1. Field of the Invention

The present invention relates to a financial data processing system and processing method and in particular, to financial data processing system and method for providing investment information to an investor making an investment according to enterprise financial data.

2. Description of the Related Art

Conventionally, a retail investor usually evaluates an investment objective enterprise by referencing investment judgment information (rating) disclosed in the Web site on the Internet. A securities firm provides information to its customers from the Web site by estimating profits obtained by investment in a stock and a bond according to the enterprise settlement information and management information and the risk involved in the investment by using indexes of five stages or so. A retail customer opens an account in his/her securities firm, acquires rating information, and makes an investment.

The rating information is created by a security analyst belonging to the securities firm. The analyst creates the rating by collecting management index calculated from accounting information such as settlement result, non-numeric information by news release, and information acquired from his/her own information source and judging these factors together. An objective enterprise is normally a famous enterprise, which makes calculation by using its unique system and discloses information only to its customers.

As a system handling a security, there have been suggested a security operation management system characterized in that an investor can freely decide the name contained in the security (refer to JP-A-2003-296564) and an investment system characterized in that an investment objective is recommended according to an investor profile and investment preference (refer to Dowd et al U.S. Pat. No. 6,609,110).

Recently, as an electronic format of financial information as the judgment material, XBRL (eXtensible Business Reporting Language) is used (XBRL™ is a trade mark of the American Institute of Certified Public Accountants (AICPA)). The XBRL is XML-based language standardized so that various information for financial reports can be created, circulated and utilized. The XBRL is a standard specification for describing the financial information in the XML format. The XBRL consists of a dictionary (taxonomy) describing the account subject information and the relationship between the subjects and data (instance) describing the financial information to be reported. In the taxonomy, various information associated with the account subjects are described by using the XLink specification format describing the link relationship by XML.

### SUMMARY OF THE INVENTION

When creating an investment decision-making system for a retail customer by using the financial information described in the XBRL format according to the conventional technique, there have been problems as follows.

Since the XBRL includes values of a plenty of account subjects (about 4000), if they are presented as they are to an end user, the end user cannot decide which values should be taken into consideration. Moreover, in the XBRL system, management index can be calculated and presented by using the conventional rule base function. However, no rule for calculating the rating for investment evaluation has been defined. Moreover, the rating method of the security analyst can be made evaluation definition based on the rule base specification but it is impossible to synthetically judge an evaluation result by a plurality of evaluation definitions.

It is therefore an object of the present invention to provide an investment decision-making information for synthetically judging the financial information described in the XBRL format by using a plurality of evaluation definitions.

In order to achieve the aforementioned object, the present invention has a configuration to acquire financial data corresponding to an evaluation object enterprise from a financial database storing financial data described in a structured language, create investment evaluation of the evaluation object enterprise according to the financial data acquired and according to a specified evaluation definition, and create overall investment evaluation for the evaluation object enterprise according to a plurality of investment evaluations created.

Other objects, features and advantages of the invention will become apparent from the following description of the embodiments of the invention taken in conjunction with the accompanying drawings.

### BRIEF DESCRIPTION OF THE DRAWINGS

FIG. 1 shows a configuration of an XBRL analysis system according to an embodiment of the present invention.

FIG. 2 shows the structure of XBRL-formatted financial data used in this invention.

FIG. 3 shows a processing flow of an overall investment evaluation creation program 111.

FIG. 4 shows a configuration of overall investment evaluation data created by the overall investment evaluation creation program 111.

FIG. 5 shows a screen displayed by a client 140 according to a second embodiment of this invention.

FIG. 6 shows a screen displayed by the client 140 in a third embodiment and a fourth embodiment of this invention.

FIG. 7 shows a configuration of a charge management table in a sixth embodiment of this invention.

### DETAILED DESCRIPTION OF THE EMBODIMENTS

Description will now be directed to embodiments of the present invention with reference to the attached drawings. It should be noted that the present invention is not to be limited to the embodiments.

### Embodiment 1

The first embodiment explains an overall investment evaluation information creation method by using the XBRL-formatted financial information. Here, the XBRL-formatted financial information is financial data described by the XBRL which is a structured language. More specifically, financial data is described extendable tag-equipped description language (structured language having data item surrounded by a tag and defined).

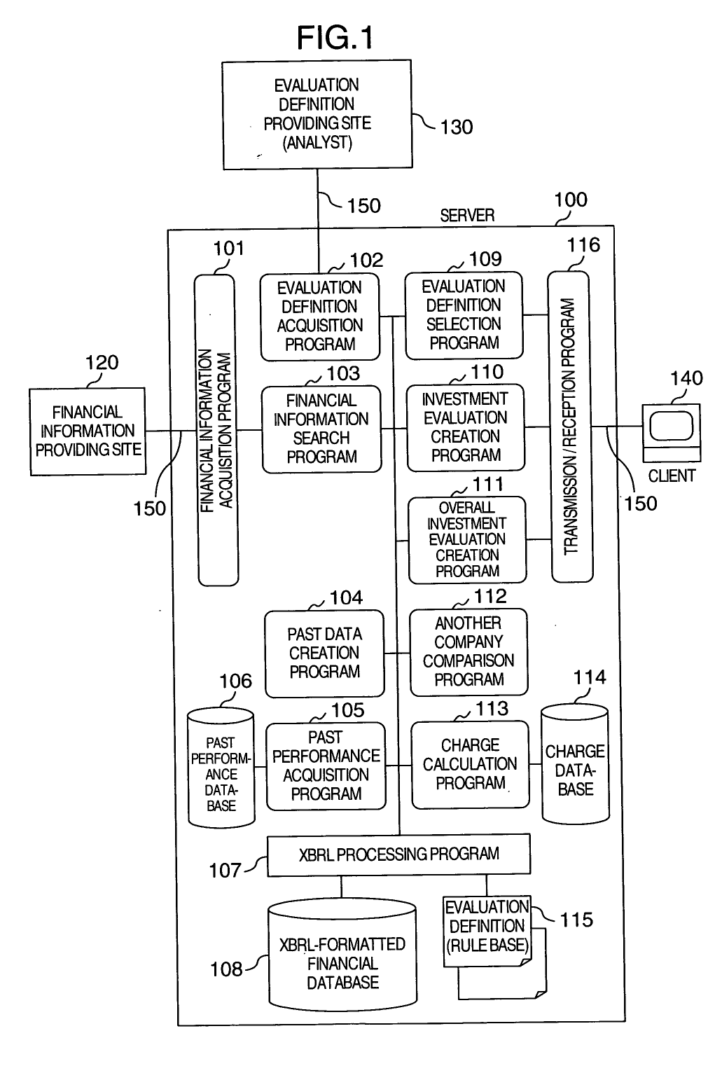

FIG. 1 shows configuration of a financial data processing system. As shown in FIG. 1, a server 100 is connected to a financial information providing site 120, an evaluation definition providing site 130, and a client (terminal) 140 via a network 150.

The server 100 includes a financial information acquisition program 101, an evaluation definition acquisition program 102, a financial information search program 103, a past data creation program 104, a past performance acquisition program 105, an XBRL processing program 107, an evaluation definition selection program 109, an investment evaluation creation program 110, an overall investment evaluation creation program 111, a company-to-company comparison program 112, a charge calculation program 113, a transmission/reception program 116, a past performance database 106, an XBRL-formatted financial database, a charge database 114, and an evaluation definition file 115.

When a retail customer inputs a name of company whose evaluation as an investment objective and a plurality of evaluation definition names into the client 140, the client 140 transmits the information which has been input via a network 150 to the server 100. The information is received by the transmission/reception program 116 of the server 100, which in turn transmits the information to the overall investment evaluation creation program 111. The overall investment evaluation creation program 111 calls the investment evaluation creation program 110, the financial information search program 103, and the like and creates an overall investment evaluation from the evaluation definition name received and the financial data of the enterprise (XBRL-formatted financial data stored in the XBRL-formatted financial database 108), which is transmitted to the transmission/reception program 116. The transmission/reception program 116 receives the overall investment evaluation and transmits it to the client 140. The client 140 displays the overall investment evaluation.

Moreover, the XBRL-formatted financial database 108 stores financial data) XBRL-formatted) for each of the enterprises. If the XBRL-formatted financial database 108 does not store financial data of a certain enterprise, the financial information acquisition program of the server 100 acquires the financial data corresponding to the enterprise from the financial information providing site 120. If the financial data is described in the XBRL format, it is directly store in the XBRL-formatted financial database. If the financial data is not described in the XBRL format, the XBRL processing section 107 subjects the financial data to the XBRL processing so as to convert it into XBRL-formatted financial data, which is stored in the XBRL-formatted financial database 108.

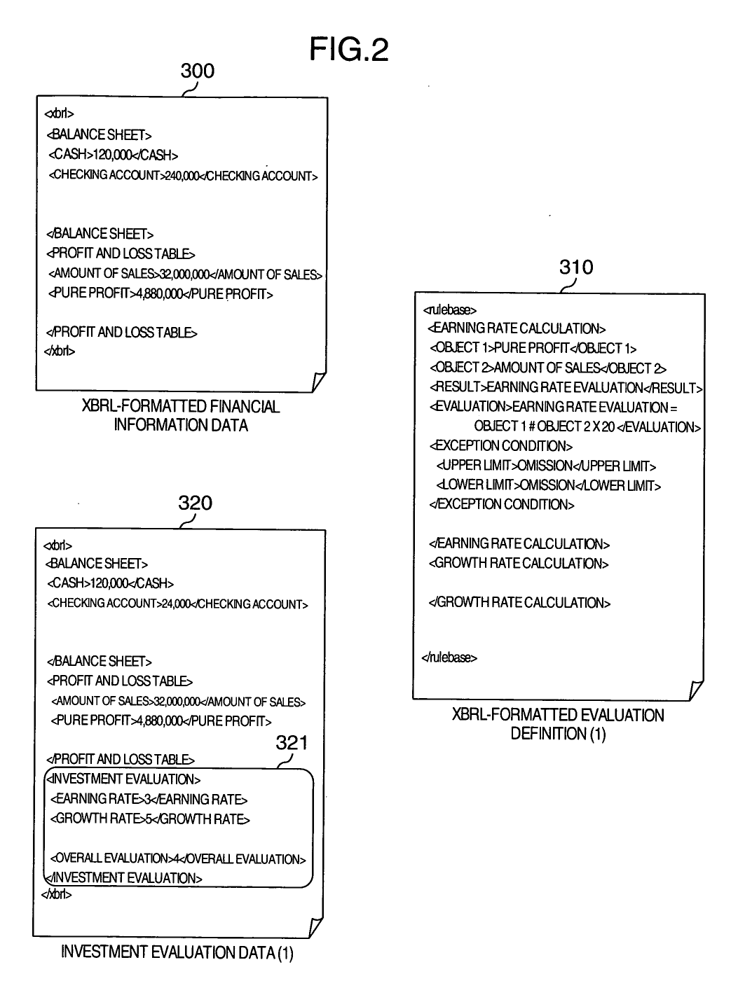

FIG. 2 shows an example of XBRL-formatted data in the first embodiment. The XBRL-formatted financial information data 300 has such configuration that an element name (such as “cash” and “the amount sold”) corresponds to an account subject and the element value (such as “120,000”) is a value of the account subject. This XBRL-formatted financial information data 300 is stored in the XBRL-formatted financial database 108 in FIG. 1 while corresponding to the enterprise name and the accounting period. Thus, in the XBRL-formatted data, each item (such as “balance sheet”, “cash”, “the amount sold”) is surrounded by a tag (“<” and “>”) and defined.

The XBRL-formatted evaluation definition 310 has a calculation method for calculating an evaluation result. Each evaluation item has an element. The element name (such as “profit calculation”) is an evaluation item name and has information on a calculation object account subject (such as “object 1”), an evaluation result item (such as “result”), and a calculation method “such as “evaluation”) as child elements. This XBRL-formatted evaluation definition 310 may be owned as the evaluation definition 115 by the XBRL analysis system or may be owned by an external site such as the evaluation definition providing site 130 (FIG. 1). The investment evaluation data 320 has configuration that the investment evaluation element 321 is added to the XBRL-formatted financial information data 300. The investment evaluation element 321 has information on the evaluation item (such as “profitability” and a value corresponding to it as child elements and an overall evaluation. As an evaluation item, it is also possible to use management index.

The aforementioned embodiment has been given as an example. Configuration applicable to the XBRL rule base specification can be applied to the present invention. Accordingly, the present invention is not to be limited to the aforementioned configuration.

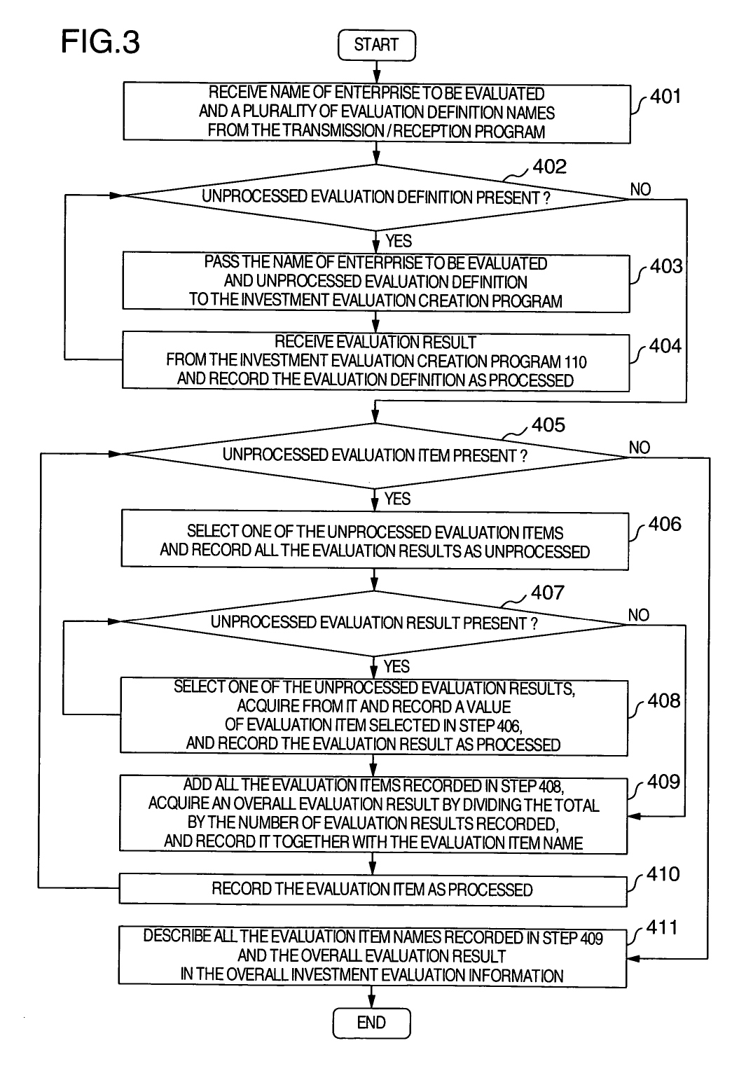

FIG. 3 shows an example of a flow of the overall investment evaluation creation program in the first embodiment. The overall investment evaluation creation program 111 receives the name of an enterprise to be evaluated as identification of the enterprise to be evaluated and a plurality of evaluation definition names which have been input from the client 140, via the transmission/reception program 116 (step 401). Here, the enterprise identification includes an enterprise code, enterprise name and data representing an enterprise. Next, it is judged whether the evaluation definition corresponding to the evaluation definition names received in step 401 contain an unprocessed evaluation definition (step 402). If Yes, the overall investment evaluation creation program 111 transmits the enterprise name to be evaluated and the unprocessed evaluation definition to the investment evaluation creation program 110 (step 403). The investment evaluation creation program 110 creates investment evaluation by using the unprocessed evaluation definition according to the financial data of the enterprise to be evaluated, acquired in advance and transmits it to the overall investment evaluation creation program 111. The overall investment evaluation creation program 111 receives the transmitted investment evaluation and records the aforementioned unprocessed evaluation definition as processed (i.e., created) (step 404). Control is passed to step 402. That is, the processes of steps 402 to 404 are repeated until all the evaluation definitions received in step 401 are processed.

In step 402, if no unprocessed evaluation definition is present, the overall investment evaluation creation program 111 judges whether an unprocessed evaluation item is contained in the evaluation definition received in step 401 (step 405). If yes, one of the unprocessed evaluation items is selected and all the evaluation results corresponding to the evaluation item are recorded as unprocessed (step 406).

Next, it is judged whether an unprocessed evaluation result is included in the evaluation results corresponding to the evaluation item (step 407). If any unprocessed evaluation results are included, one of the unprocessed evaluation results is selected, a value corresponding to the evaluation item (unprocessed evaluation item) selected in step 406 is acquired from the financial information data on the enterprise to be evaluated so as to be recorded, and the aforementioned evaluation result is recorded as processed (step 408). Then, control is passed to step 407. That is, the processes of steps 407 and 408 are repeated until all the evaluation results recorded as unprocessed in step 406 are processed.

In step 407, if no unprocessed evaluation result is present, values of all the evaluation items recorded in step 408 are added to obtain a sum. The sum is divided by the number of evaluation results recorded to calculate an overall evaluation result, which is recorded together with the evaluation item name (step 409). The evaluation item which has been selected in step 406 is recorded as processed (step 410) and control is passed to step 405. That is, the processes of steps 405 to 410 are repeated until all the evaluation items in the evaluation definition received in step 401 become processed.

In step 405, if no unprocessed evaluation item is present, all the evaluation item names and the overall evaluation result recorded in step 408 are described in the overall investment evaluation information (step 411). Thus, finally, the overall investment evaluation information is created.

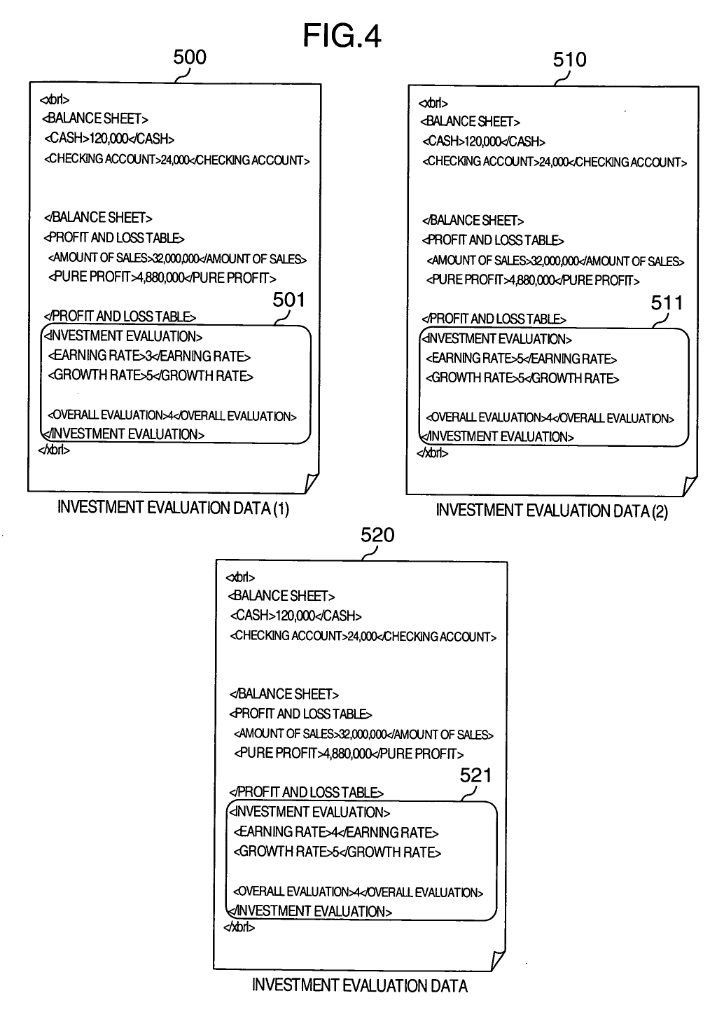

FIG. 4 shows an example of overall investment evaluation data crated by the overall investment evaluation creation program 111. The investment evaluation data 500 is data having an investment evaluation element 501 in the XBRL-formatted financial information data 320 (FIG. 2). The investment evaluation data 510 is data having an investment evaluation element 511 in the XBRL-formatted financial information data 320. The overall investment evaluation data 520 is data having an overall investment evaluation element 521 in the XBRL-formatted financial information data 320. The overall investment evaluation element 521 has an element identical to the investment evaluation elements 501 and 511 but has an average value of the investment evaluation elements 501 and 511 as an element value.

By performing the aforementioned method, a retail customer (investor) can acquire overall investment decision-making information by using a plurality of evaluation definitions.

As has been described above, the XBRL includes a dictionary (taxonomy) describing the account subject information and inter-subject relationship and data (instance) describing financial information to be reported. In the taxonomy, various information on the account subject can be flexibly described by using the XLink specification describing the link relationship by XML. By using the XBRL format, it is possible to create circulate, and re-use electronic financial information regardless of software or platform.

Moreover, by describing various information on the account subject in the taxonomy, only the least data can be described with a simple structure in the instance. By creating the financial information by using the XBRL, the enterprise can obtain merits of rapid information disclosure and simplified report to an inspection corporation and supervisory authorities.

### Embodiment 2

Embodiment 2 explains an overall investment evaluation information creation method by using the ratio distribution information for the evaluation definition.

When a retail customer (investor) inputs an enterprise name whose evaluation as an investment objective he/she wants, a plurality of evaluation definition names, and a distribution ratio value for each evaluation definition to the client 140, the client 140 transmits the information which has been input to the server 100 via the network 150. When the transmission/reception program 116 in the server 100 receives the information, it transfer the information to the overall investment evaluation creation program 111. According to the information received, the overall investment evaluation creation program 111 executes the steps 402 to 408 in the processing flow shown in FIG. 3. The overall investment evaluation creation program 111 multiplies the evaluation item recorded in step 408 in FIG. 3 by the distribution ratio value (weight) set for each evaluation definition, calculates an overall evaluation result by adding the calculation results, and records it together with the evaluation item name. Then, the overall investment evaluation creation program 111 executes steps 410 and 411 in FIG. 3.

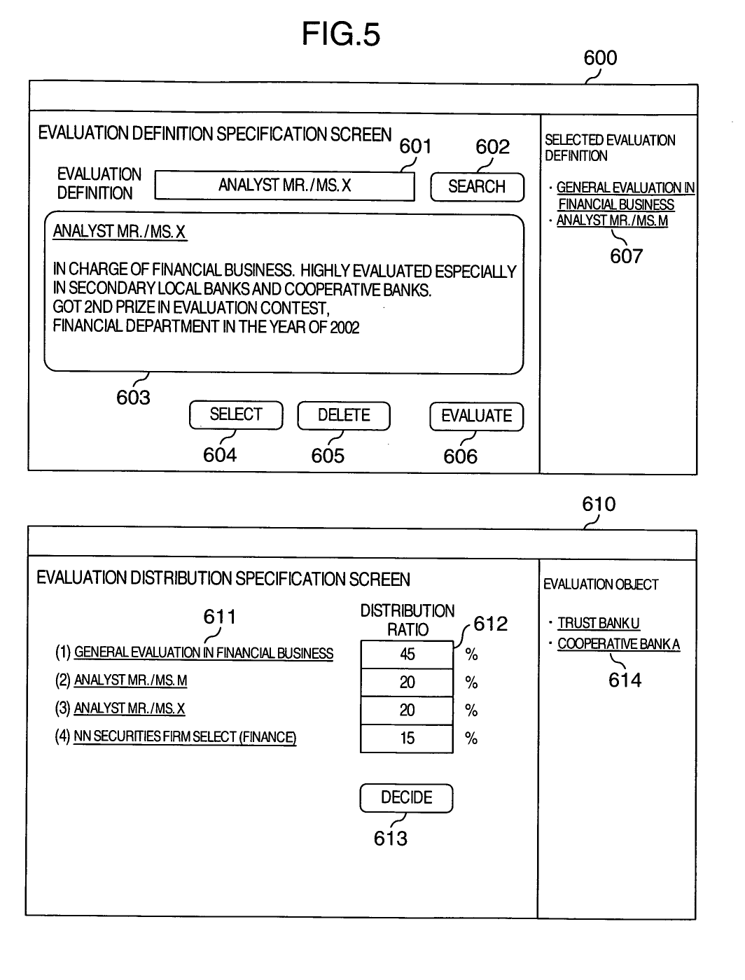

FIG. 5 shows an example of a screen displayed by the client 140 in the second embodiment. The evaluation definition specification screen 600 has an evaluation definition name input column 601, a search execution button 602, an evaluation definition explanation display area 603, a selection execution button 604, a delete execution button 605, an evaluation execution button 606, and a selected evaluation definition name display area 607.

The evaluation definition specification screen 600 is a screen for specifying the evaluation definition. The evaluation definition name input column 601 is a column for inputting an evaluation definition name to be specified. The search execution button 602 is a button for instructing execution of search of the evaluation definition to be specified. The evaluation definition explanation display area 603 is an area for displaying explanation on the evaluation definition described in the evaluation definition name input column 601. The selection execution button 604 is pressed when the use of the evaluation definition described in the evaluation definition name input column 601 is to be decided. the delete execution button 605 is used to instruct deletion of the use of the evaluation definition described in the evaluation definition name input column 601. The evaluation execution button 606 is used to instruct recording of a plurality of evaluation definition whose use has been decided. When this button is pressed, the screen is changed to the evaluation distribution specification screen 610. The selected evaluation definition name display area 607 is an area for displaying a plurality of evaluation definition names whose use has been decided.

When the retail customer (investor) presses the search execution button 602 in the evaluation definition specification screen 600 displayed in the client 140, the client 140 acquires a list of evaluation definition names displayed. When the retail customer presses the name of the evaluation definition which he/she wants to select, the client 140 displays the evaluation definition name to be selected in the evaluation definition name input column 601 and displays explanation on the corresponding evaluation definition in the evaluation definition explanation display area 603. When the retail customer presses the selection execution button 604, the evaluation definition name selected is added to the selected evaluation definition name display area 607. When an evaluation definition name in the selected evaluation definition name display area 607 is pressed, the client 140 displays the evaluation definition name selected in the evaluation definition name input column 601 and displays the explanation on the evaluation definition in the evaluation definition explanation display area 603. When the retail customer presses the delete execution button 605, the evaluation definition name selected is deleted from the selected evaluation definition name display area 607. When the retail customer presses the evaluation execution button 606, the client 140 displays the evaluation distribution specification screen 610.

The evaluation distribution specification screen 610 has a selected evaluation definition list 611, a distribution ration input column 612, a distribution ratio decision button 613, and an area for displaying a list of enterprises to be evaluated 614.

The evaluation distribution specification screen 610 is a screen for specifying the ratio of application distribution for a plurality of evaluation definitions which have been decided to be used by the retail customer. The selected evaluation definition list 611 displays a list of a plurality of evaluation definition names which have been decided to be used by the retail customer by pressing the selection button in the evaluation definition specification screen 600. The distribution ratio input column 612 is a column for describing the application distribution ratio for each of the evaluation definitions displayed in the selected evaluation definition list 611.

The distribution ratio decision button 613 is used to transmit the evaluation definition displayed in the selected evaluation definition list 611, the distribution ratio described in the distribution ratio input column 612, and the enterprise name displayed in the area for displaying a list of the enterprises to be evaluated 614 to the server 100 and instruct execution of evaluation result data creation. The area for displaying a list of the enterprises to be evaluated 614 is an area for displaying a plurality of enterprise names to be evaluated.

When the retail customer describes the distribution ratio value to be reflected to the overall evaluation of evaluation definition in the distribution ratio input column 612 and presses the distribution ratio decision button 613, the client 140 transmits the aforementioned information which has been input, to the server 100. According to the information such as the distribution ratio received, the server 100 creates an overall investment evaluation according to the processing flow shown in FIG. 3.

By the aforementioned method, a retail customer can acquire collective investment decision-making information by using a plurality of evaluation definitions added by the distribution ratio.

### Embodiment 3

The third embodiment explains the overall investment evaluation information creation method using enterprise information as a reference. When a retail customer (investor) inputs a name of the enterprise whose evaluation he/she wants to obtain as an investment objective, a plurality of evaluation definition names, and a distribution ratio value for each evaluation definition into the client 140, the client 140 transmits the aforementioned information to the server 100 via the network 150. When the transmission/reception program 116 in the server 100 receives the aforementioned information, it passes the information to the overall investment evaluation creation program 111. The overall investment evaluation creation program 111 executes the processing described in the second embodiment and acquires the overall investment evaluation data for the enterprise to be evaluated. The overall investment evaluation creation program 111 passes the name of the enterprise to be evaluated to another enterprise comparison program 112. The another enterprise comparison program 112 returns the name of the enterprise serving as a reference in the business type of the enterprise to be evaluated, to the overall investment evaluation creation program 111. The overall investment evaluation creation program 111 also executes the processing described in the second embodiment similarly for the acquired enterprise serving as the reference and acquires the overall investment evaluation data. The overall investment evaluation creation program 111 passes to the transmission/reception program 116 the overall investment evaluation data on the enterprise to be evaluated and the overall investment evaluation data on the enterprise as a reference. The transmission/reception program 116 transmits the aforementioned two data to the client 140. The client 140 displays the two data side by side.

By performing the aforementioned method, comparison is made with the overall investment judgment information for the enterprise serving as a reference and a retail customer (investor) can know the validity of the investment judgment information for the enterprise to be evaluated.

### Embodiment 4

In the fourth embodiment, explanation will be given on the overall investment evaluation information creation method using the past investment evaluation data and the past investment performance data on the enterprise to be evaluated.

When a retail customer (investor) inputs the name of the enterprise to be evaluated as an investment objective, a plurality of evaluation definition names, and the distribution ratio value for each evaluation definition into the client 140, the client 140 transmits these information to the server 100 via the network 150. The transmission/reception program 116 in the server 100 transfers the information received to the overall investment evaluation creation program 111. The overall investment evaluation creation program 111 executes the processing flow shown in FIG. 3 explained in the second embodiment and acquires overall investment evaluation data on the enterprise to be evaluated.

Moreover, the overall investment evaluation creation program 111 transfers the name of the enterprise to be evaluated to the past data creation program 104. The past data creation program 104 searches the XBRL-formatted financial database 108, acquires XBRL-formatted financial information data on the enterprise to be evaluated and issued in the past (such as the previous accounting period), and transmits it to the overall investment evaluation creation program 111. The overall investment evaluation creation program 111 executes the processing explained in the second embodiment by using the financial information data on the previous accounting period received and a plurality of evaluation definition names and the distribution ratio value for each evaluation definition transmitted from the client 140, thereby acquiring overall investment evaluation data in the previous accounting period.

Furthermore, the overall investment evaluation creation program 111 transmits the name of the enterprise to be evaluated to the past performance acquisition program 105. The past performance acquisition program 105 searches the past performance database 106 and acquires investment performance in the preceding accounting period. The past result acquisition program 105 transmits the investment performance acquired to the overall investment evaluation creation program 111.

The overall investment evaluation creation program 111 compares the overall investment evaluation data in the preceding accounting period to the investment performance and judges validity of the overall investment evaluation in the preceding accounting period or the evaluation definition used for creating the overall investment evaluation creation. That is, if difference between the data is smaller than a first predetermined value, the validity is decided to be “high”. If the difference between the data is greater than a second predetermined value, the validity is decided to be “low”. If the difference between the data is within a predetermined value range (i.e., not smaller than the first predetermined value and not greater than the second predetermined value), the validity is decided to be “intermediate”. The overall investment evaluation creation program 111 passes the overall investment evaluation data for the enterprise to be evaluated, the overall investment evaluation data in the preceding accounting period, the investment performance, and the aforementioned validity to the transmission/reception program 116. The transmission/reception program 116 transmits the aforementioned data to the client 140. The client displays the data received.

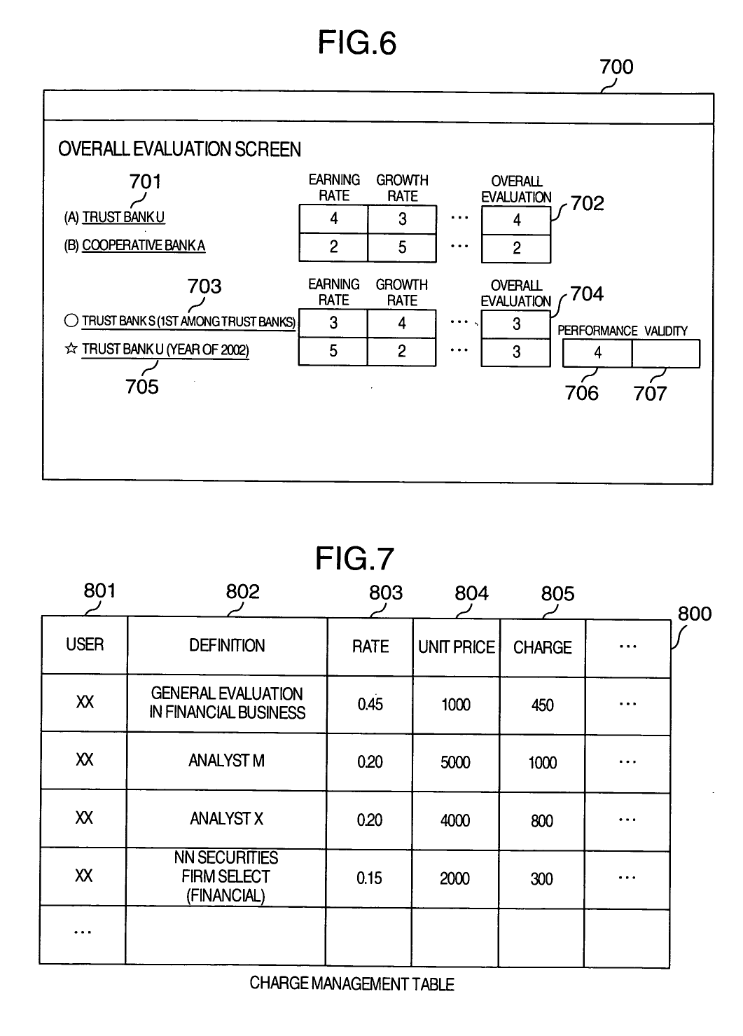

FIG. 6 shows an example of screen displayed by the client 140 in the third and the fourth embodiment. The overall evaluation screen 700 has a list of enterprise names to be evaluated 701, overall evaluation data display column 702, an area for displaying an enterprise name serving as a reference in the business category 703, an overall evaluation data display column 704, an area for displaying an enterprise name in the preceding accounting period 705, a column for displaying the investment performance in the preceding accounting period 706, and a column for displaying validity of the investment evaluation in the preceding accounting period 707.

The list of enterprise names to be evaluated 701 is a column for displaying a list of the enterprise names to be evaluated which has been created by the server 100. The overall evaluation data display column 702 is a column for displaying evaluation corresponding to the list of enterprise names to be evaluated 701. The enterprise name display area 703 serving as a reference in the business category is an area for displaying an enterprise name serving as a reference in the business category of the enterprise to be evaluated. The overall evaluation data display column 704 is a column for displaying evaluation corresponding to the reference enterprise name. The area for displaying an enterprise name in the preceding accounting period 705 is an area for displaying an enterprise name to be evaluated and the preceding accounting period name (such as 2002 business year). The column for displaying the investment performance in the preceding accounting period 706 is a column for displaying the enterprise name to be evaluated and the investment performance of preceding accounting period. The column for displaying validity of the investment evaluation in the preceding accounting period 707 is a column for displaying the enterprise name to be evaluated and the evaluation definition validity decided by comparing the investment evaluation result data on the preceding accounting period to the investment performance.

By performing the aforementioned method, the evaluation definition application result for the preceding accounting period of the enterprise to be evaluated is compared to the investment performance in the preceding accounting period, so that a retail customer (investor) can know the validity of the investment judgment information for the enterprise to be evaluated.

### Embodiment 5

Embodiment 5 explains the overall investment evaluation information creation method for acquiring an evaluation definition from the evaluation definition providing site. In this case, a security analyst defines the evaluation method and registers it in advance in the evaluation definition providing site 130.

When a retail customer inputs the name of the enterprise whose evaluation he/she wants as an investment objective, a plurality of evaluation definition names, and the distribution ratio value for each evaluation definition to the client 140, the client 140 transmits the input information to the server 100 via the network 150. The transmission/reception program 116 in the server 100 transmits the information received from the client 140, to the overall investment evaluation creation program 111.

The overall investment evaluation creation program 111 executes steps 402 and 403 in the processing flow (FIG. 3) described in the second embodiment. The investment evaluation creation program 110 which has received the enterprise name to be evaluated and the evaluation definition name from the overall investment evaluation creation program 111 acquires the financial information data corresponding to the enterprise name to be evaluated from the XBRL-formatted financial database 108 and searches whether the server 100 stores an evaluation definition corresponding to the aforementioned evaluation definition name. If the corresponding evaluation definition is present in the server 100, the investment evaluation creation program 110 acquires the evaluation definition and transmits the aforementioned financial information data and the aforementioned evaluation definition to the XBRL processing program 107. The XBRL processing program 107 creates evaluation result data based on the financial information and evaluation definition received and transmits the data to the investment evaluation creation program 110.

If the server 100 stores no evaluation definition corresponding to the enterprise name to be evaluated, the investment evaluation creation program 110 transmits the evaluation definition name to the evaluation definition acquisition program 102. The evaluation definition acquisition program 102 transmits the received evaluation definition name to the evaluation definition providing site 130. The evaluation definition providing site 130 searches the evaluation definition corresponding to the aforementioned evaluation definition name received and transmits the acquired evaluation definition to the evaluation definition acquisition program 102. The evaluation definition acquisition program 102 transmits the received evaluation definition to the investment evaluation creation program 110.

The investment evaluation creation program 110 transmits the aforementioned financial information data corresponding to the enterprise name to be evaluated and the evaluation definition to the XBRL processing program 107. The XBRL processing program 107 searches the XBRL-formatted financial database 108, acquires the evaluation result data, and transmits it to the investment evaluation creation program 110. The investment evaluation creation program 110 transmits the received evaluation result data to the overall investment evaluation creation program 111. The overall investment evaluation creation program 111 executes the processing of step 404 and after (FIG. 3) described in the second embodiment.

By performing the aforementioned method, it is possible to acquire an evaluation definition from an external evaluation definition providing site even if the server 100 does not store an evaluation definition which a retail customer wants to use. Thus, the retail customer can effectively acquire investment decision-making information without referencing a plenty of sites.

It should be noted that in this embodiment, explanation has been given on a case that the server 100 does not store an evaluation definition which a retail customer wants to use and an evaluation definition is acquired from an external evaluation definition providing site. However, it is also possible to acquire an evaluation definition from the external definition providing site even when the server 100 stores an evaluation definition which the retail customer wants to use. In this case, by utilizing a plurality of evaluation definitions, it is possible to obtain an overall investment evaluation according to a greater amount of information.

### Embodiment 6

Embodiment 6 explains the overall investment evaluation information creation method which decides the charge by utilizing the evaluation definition application distribution ratio.

When the retail customer inputs the name of the enterprise to be evaluated as an investment objective, a plurality of evaluation definition names, and the distribution ratio value for each evaluation definition into the client 140, the client 140 transmits the input information to the server 100 via the network 150. The transmission/reception program 116 in the server 100 transfers the transmitted information to the overall investment evaluation creation program 111. The overall investment evaluation creation program 111 executes the processing described in the second embodiment (FIG. 3) according to the information received and acquires overall evaluation result data.

Next, the overall investment evaluation creation program 111 searches the charge information table in the charge database 114 and acquires the charge unit cost information for each of a plurality of evaluation definitions. The overall investment evaluation creation program 111 multiplies corresponding distribution ratio by the aforementioned charge for each of the plurality of evaluation definitions and calculates the charge. Moreover, for each of the plurality of evaluation definitions, the overall investment evaluation creation program 111 correlates the name of the retail customer (investor) using it, the evaluation definition name, the distribution ratio, the user fee unit cost, and the charge and stores them in the charge management table in the charge database 114.

FIG. 7 shows an example of configuration of the charge management table in the charge database 114 and data contents. The charge management table 800 has a user column 801, a definition column 802, a ratio column 803, a unit cost column 804, and a charge column 805. The charge management table is a table in which a retail customer stores a u se fee for the evaluation definition used for investment decision-making.

The user column 801 is used to store a name of a user (retail customer). The definition column 802 is used to store an evaluation definition name used by the user who has been stored in the user column 801. The ratio column 803 is used to store the distribution ratio value corresponding to the evaluation definition stored in the definition column 802. The unit cost column 804 is used to store a charge unit cost corresponding to the evaluation definition stored in the definition column 802. The charge column 805 Is used to store a charge corresponding to the evaluation definition stored in the definition column 802.

As has been described above, the charge is calculated according to the ratio of evaluation definitions used by the retail customer for investment decision-making and the service provider managing the server 100 returns the evaluation definition charge to an analyst. Thus, the analyst can get the charge as consideration for providing evaluation definitions. That is, it is possible to give an incentive to the analyst to provide evaluation definitions.

Moreover, it is possible to present ranking according to the number of uses of the evaluation definition provided by an analyst so that a retail customer can use the ranking and the retail customer can decide the evaluation definition used when evaluating the enterprise according to the result.

By the aforementioned, it is possible to increase the number of users of the investment evaluation providing site for retail customers of a securities firm and the site manager can get a merit of increase of charge. Moreover, by the aforementioned site, the investment cost of a retail customer can be reduced and more capital can be assigned for investment, which in turn increases the capital an enterprise get, thereby enlarging the investment market. Moreover, by circulating the evaluation definition of an analyst and providing charge according to the performance, it is possible to introduce the principle of free competition in the analysis market and it becomes possible to perform better investment decision-making.

It should be further understood by those skilled in the art that although the foregoing description has been made on embodiments of the invention, the invention is not limited thereto and various changes and modifications may be made without departing from the spirit of the invention and the scope of the appended claims.

1. A financial data processing system for processing financial data for each enterprise, the system comprising:
a financial database storing financial data described in a structured language;
a reception unit for receiving an identification of an enterprise to be evaluated and an evaluation definition name for evaluating the enterprise to be evaluated,
a financial information search unit for searching and acquiring financial data corresponding to the received enterprise identification among the financial data stored in the financial database,
an investment evaluation creation unit for creating an investment evaluation of the enterprise-to-be-evaluated corresponding to the financial data by using the acquired financial data based on an evaluation definition corresponding to the evaluation definition name, said evaluation definition being described in the structured language, and
an overall investment evaluation creation unit for creating an overall investment evaluation for the enterprise to be evaluated based on a plurality of investment evaluations created by the investment evaluation creation unit when a plurality of evaluation definition names are received by the reception unit.

2. A financial data processing system as claimed in claim 1, wherein if a weight is set for each of the plurality of evaluation definition names, the overall investment evaluation creation unit creates an overall investment evaluation according to the investment evaluation created by the evaluation definition and the weight.

3. A financial data processing system as claimed in claim 1, the system further comprising:
another company comparison unit for receiving the enterprise identification from the overall investment evaluation creation unit and transmitting a reference enterprise identification corresponding to the enterprise-to-be-evaluated to the overall investment evaluation creation unit,
wherein the overall investment evaluation creation unit creates an overall investment evaluation of the enterprise to be evaluated and an overall investment evaluation on the reference enterprise identification received.

4. A financial data processing system as claimed in claim 1, the system further comprising:
a past data creation unit for acquiring past financial data corresponding to the enterprise-to-be-evaluated from the financial database;
a past performance database for storing a past investment performance of the enterprise to be evaluated; and
a past performance acquisition unit for acquiring the past investment performance corresponding to the enterprise-to-be-evaluated from the past performance database;
wherein the overall investment evaluation creation unit creates an overall investment evaluation for the past financial data by using the plurality of evaluation definitions according to the past financial data acquired by the past data creation unit and receives the past investment performance acquired by the past performance acquisition unit.

5. A financial data processing system as claimed in claim 1, the system further comprising:
a charge database for storing a charge corresponding to the evaluation definition described in the structured language; and
a charge calculation unit for acquiring a charge corresponding to the evaluation definition used for creation of the overall investment evaluation from the charge database and calculating a charge for each of the evaluation definitions.

6. A financial data processing system as claimed in claim 5, wherein if an evaluation weight is set for each evaluation definition on the enterprise-to-be-evaluated, the charge calculation unit decides the charge of the evaluation definition according to the charge corresponding to the evaluation definition and the weight.

7. A financial data processing system as claimed in claim 1, the system further comprising:
an evaluation definition acquisition unit for acquiring an evaluation definition corresponding to the evaluation definition name from an external device if the evaluation definition corresponding to the evaluation definition name received is not contained in the financial data processing system;
wherein the investment evaluation creation unit creates an investment evaluation according to the evaluation definition acquired, and
the overall investment evaluation creation unit creates an overall investment evaluation according to the investment evaluation created.

8. A financial data processing system as claimed in claim 4, wherein the overall investment evaluation creation unit compares the overall investment evaluation for the past financial data to the past investment performance and decides the validity of the overall investment evaluation for the past financial data.

9. A financial data processing system as claimed in claim 1, wherein
the structured language is a language having a tag which can be extended, and
the item contained in the financial data is described and defined together with the tag.

10. A financial data processing system as claimed in claim 9, wherein the language having a tag which can be extended is XBRL.

11. A financial data processing method in a financial data processing system including a terminal operated by a user and a server connected to the terminal for processing financial data, the method comprising the steps of:
transmitting, by the terminal, an identification of an enterprise-to-be-evaluated and an evaluation definition name input by the user, to the server;
acquiring, by the server, financial data corresponding to the enterprise identification transmitted from the terminal from a financial database storing financial data and described in a structured language;
creating, by the server, an investment evaluation of the enterprise-to-be-evaluated by using the acquired financial data based on an evaluation definition corresponding to the evaluation definition name, said evaluation definition being described in the structured language;
creating, by the server, an overall investment evaluation for the enterprise-to-be-evaluated based on a plurality of evaluation definitions if there are a plurality of processed evaluation definitions; and
transmitting, by the server, the overall investment evaluation created to the terminal.

12. A financial data processing method as claimed in claim 11, further comprising the steps of:
acquiring, by the server, an evaluation definition corresponding to the evaluation definition name from an evaluation definition providing site connected to the server if the evaluation definition corresponding to the evaluation definition name transmitted from the terminal is not contained in the server; and
creating, by the server, an overall investment evaluation for the enterprise-to-be-evaluated according to the evaluation definition acquired.

13. A financial data processing method as claimed in claim 11, further comprising the steps of:
acquiring past financial data on the enterprise to be evaluated from the financial database;
creating an overall investment evaluation for the past financial data by using the plurality of evaluation definitions according to the past financial data;
acquiring the past investment performance of the enterprise to be evaluated from the past performance database; and
transmitting the overall investment evaluation for the past financial data and the past investment performance to the terminal.

14. A financial data processing method as claimed in claim 13, further comprising the step of:
displaying, by the terminal, the overall investment evaluation for the past financial data and the past investment performance.

15. A financial data processing method as claimed in claim 13, further comprising the steps of:
comparing, by the server, the past investment performance acquired to the overall investment evaluation for the past financial data; and
deciding, by the server, validity of the overall investment evaluation for the past financial data according to the comparison result.

16. A financial data processing method as claimed in claim 15, further comprising the step of:
transmitting, by the server, the investment performance acquired, the overall investment evaluation for the past financial data, and the information on the validity to the terminal.

17. A financial data processing method as claimed in claim 16, further comprising the step of:
displaying, by the terminal, the past investment performance, the overall investment evaluation for the past financial data, and the information on validity which have been transmitted from the server.

18. A financial data processing method as claimed in claim 11, further comprising the steps of:
acquiring, by the server, a charge corresponding to the evaluation definition used for creating the overall investment evaluation from the charge database; and
calculating, by the server, a charge for each of the evaluation definitions.

19. A financial data processing method as claimed in claim 18, further comprising the step of:
calculating a charge corresponding to the evaluation definition used for creating the overall investment evaluation according to the charge corresponding to the evaluation definition stored in the charge database and a weight corresponding to the evaluation definition name if information on the weight corresponding to the evaluation definition names input in the terminal is received.

20. A program executed in a financial data processing system comprising a terminal operated by a user and a server connected to the terminal for processing financial data, the program comprising the execution steps of:
receiving an identification of an enterprise to be evaluated and an evaluation definition name transmitted from the terminal;
acquiring financial data on the enterprise to be evaluated from a database storing financial data described in a structured language;
processing an evaluation definition corresponding to the evaluation definition name based on the acquired financial data;
when there are a plurality of the evaluation definitions processed as a result of the evaluation definition processing, creating an overall investment evaluation for the enterprise to be evaluated based on the plurality of processed evaluation definitions; and
transmitting the overall investment evaluation to the terminal.
